(19) United States
(12) Patent Application Publication
(10) Pub. No.: US 2009/0312472 A1
(43) Pub. Date: Dec. 17, 2009

(54) GLYCOL-FREE GLUE STICK

(75) Inventors: Cordell M. Hardy, Roseville, MN (US); John W. Frank, Cottage Grove, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/140,379

(22) Filed: Jun. 17, 2008

(51) Int. Cl. C08K 5/09

(52) U.S. Cl. 524/322; 524/300

(57) ABSTRACT

A glue stick composition includes 5 to 40 % wt polyvinylpyrrolidone; 3 to 20 % wt alkanoate blend including a first Cₙ carboxylic acid salt and a second Cₘ carboxylic acid salt, where n and m are integers in a range from 12 to 22; 20 to 60 % wt of a water-soluble or water-dispersable solid material; 0.5 to 30 wt % liquid monohydric alcohol; and 15 to 60% wt water. The glue stick composition includes less than 0.5% wt liquid polyhydric alcohol.

### BACKGROUND

The present disclosure relates to adhesives that include an alkanoate blend. More specifically the present disclosure relates to adhesive crayons (“glue sticks”) that provide reduced substrate wrinkling, improved clarity, and/or reduced clumping.

Glue sticks comprising a fatty acid salt offer smooth, even application and good adhesive properties on paper, as disclosed in U.S. Pat. No. 3,576,776 and 6,066,689. This class of adhesives may be prepared by heating an appropriate blend of polymer(s), solvent(s), and fatty acid salt(s) until all components are dissolved, filling the material into desired containers, and cooling the product to room temperature. Typically, during cooling glue stick gelation occurs as the fatty acid salts phase separate from the adhesive solution and form crystals. Once formed, fatty acid salt crystals have a tendency to scatter light, resulting in an opaque appearance. In addition to being opaque, glue sticks have a tendency to cause noticeable wrinkling on paper substrates, as well as to break into adhesive clumps during application.

### SUMMARY

The present disclosure relates to adhesives that include an alkanoate blend. More specifically the present disclosure relates to adhesives that provide increased wet tack, long open times, reduced substrate wrinkling, improved clarity, and/or reduced clumping as compared to adhesives, such as to glue sticks, that are commercially available.

One aspect relates to a glue stick composition that includes 5 to 40% wt polyvinylpyrrolidone, 3 to 20% wt alkanoate blend of a first Cₙ carboxylic acid salt and a second Cₘ carboxylic acid salt, where n and m are integers in a range from 12 to 22, 20 to 60% wt of a water-soluble or water-dispersable material, 0.5 to 30% wt of liquid monohydric alcohol, and 15 to 60% wt water. The glue stick composition further includes less than 0.5% wt liquid polyhydric alcohol.

Another aspect relates to a clear glue stick composition that includes 5 to 40% wt polyvinylpyrrolidone, 3 to 20% wt alkanoate blend of a first Cₙ carboxylic acid salt and a second Cₘ carboxylic acid salt, where n and m are integers in a range from 12 to 22, 20 to 60% wt of a water-soluble or water-dispersable material, 0.5 to 30 wt % of liquid monohydric alcohol, and 15 to 60% wt water. The clear glue stick composition is essentially free of liquid polyhydric alcohol. As measured through a section 0.125 mm thick, the clear glue stick has a light transmission of at least 75% at 400 nm, 500 nm, 600 nm, and 650 nm wavelengths.

In many embodiments, the total of the solid material, liquid monohydric alcohol, and any other water-miscible solvent concentrations is at least 50% of the total water content of the glue stick composition.

The above summary is not intended to describe each disclosed embodiment or every implementation of the present disclosure. The Detailed Description and Examples that follow more particularly exemplify these embodiments.

### DETAILED DESCRIPTION

The present disclosure relates to adhesives that include an alkanoate blend. More specifically the present disclosure relates to glue sticks that provide reduced substrate wrinkling, improved clarity, and/or reduced clumping. For the following defined terms, these definitions shall be applied, unless a different definition is given in the claims or elsewhere in this specification.

Weight percent, percent by weight, % by weight, % wt, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. Thus, for example, reference to a composition containing “a solid material” includes of two or more solid materials. As used in this specification and the appended claims, the term “or” is generally employed in its sense including “and/or” unless the content clearly dictates otherwise.

Unless otherwise indicated, all numbers expressing quantities of ingredients, measurement of properties and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The present disclosure describes adhesives that can provide decreased wrinkling when applied to paper substrates, improved clarity, and/or reduced clumping. The disclosed formulations can allow for a shorter period of time between adhesive application and substrate bonding, as compared with adhesive formulations utilizing liquid polyhydric alcohol, yet produce fiber tearing bonds instead of temporary adhesion. These attributes can be desirable for easy, permanent paper bonding and attractively bonded craft projects. These adhesives may also be useful for bonding non-paper substrates.

For a glue stick composition, one method of decreasing wrinkling during drying is to simply increase the adhesive polymer concentration and reduce the solvent concentration. This results in less wrinkling and a smaller volume change as the solvent evaporates, as well as a shorter drying time. However, this approach also tends to result in increased viscosity and manufacturing costs, as well as more friction during application.

Another method of decreasing wrinkling during drying is to exchange water for less volatile solvents such as C₃ and C₄ glycols and other water-miscible solvents. This approach also enhances the lubricity of glue sticks to impart a smooth, gliding application. Using a water-miscible, slowly evaporating solvent allows for improved stress relaxation during the drying process, such that less wrinkling occurs while the adhesive shrinks. However, this approach can dramatically reduce adhesive tack while simultaneously slowing the drying process. As a result bonded materials may need to be held in place or set aside for a lengthy period prior to use or display.

Glue sticks described herein provide reduced paper wrinkling without the drawbacks associated with methods described above. In particular, combined use of a water-soluble or water-dispersible solid with a monohydric alcohol promotes strong initial tack as compared to formulations using high levels of liquid polyhydric alcohol, and reduced substrate wrinkling. The glue sticks offer immediate adhesion to articles without undesirable pop-off or peeling and provide permanent, low-wrinkle bonds as the adhesive dries.

The glue stick composition includes a water soluble adhesive resin or polymer. In many embodiments, the water soluble adhesive resin or polymer includes a polyvinylpyrrolidone (PVP), a polyvinyl alcohol (PVOH), poly(2)ethyl-2-oxazoline, water soluble starches, water soluble starch derivatives, and/or cellulose derivatives. Although PVP is exemplified throughout this specification, any one or more of the water soluble adhesive resins or polymers can be utilized in addition to PVP or to replace PVP.

The glue stick composition includes polyvinylpyrrolidone, an alkanoate blend of a first Cₙ carboxylic acid salt and a second Cₘ carboxylic acid salt, where n and m are integers in a range from 12 to 22, water, liquid monohydric alcohol, and water-soluble or water-dispersible solids. In some embodiments, the glue stick is clear.

In many embodiments, the glue stick composition includes 5 to 40% wt polyvinylpyrrolidone, 3 to 20% wt alkanoate blend of a first Cₙ carboxylic acid salt and a second Cₘ carboxylic acid salt, where n and m are integers in a range from 12 to 22, liquid monohydric alcohol, water-soluble or water-dispersible solids, and 15 to 60% wt water. The glue stick composition includes less than 0.5 % wt liquid polyhydric alcohol and in some embodiments the glue stick composition is essentially free of such alcohol.

The alkanoate blend includes a mixture of at least two carboxylate salts having 12 to 22 carbon atoms and be either branched or straight chain, and may have one or more double bonds or one or more substituents such as, for example, a halogen. The alkanoate blend can be used to improve many features of the glue stick, such as to produce a stick product having enhanced translucence and/or smoother application. If the glue stick is not sufficiently firm it may fracture or break during application, resulting in deposition of pieces of adhesive, i.e., “clumps” on the adherend rather than a smooth continuous adhesive film. This fracture and accompanying deposition of adhesive pieces during application is referred to as “clumping”.

While not wishing to be bound by any particular theory, we believe the enhanced translucence and reduced clumping of the inventive glue sticks containing an alkanoate blend results from accessing soap gel microstructures that feature amorphous association of hydrocarbon chains. Additionally, it has been found that introducing certain adjuvants having refractive indices complimentary to the soap gel microstructure can further improve glue stick translucency. These adjuvants may include, but are not limited to, sucrose, sorbitol, and other solid water-soluble carbohydrates.

Thus, glue stick compositions of the instant invention contain (1) alkanoate blends, which hinder ordering of aliphatic groups in the soap gel microstructure, and (2) solid materials having a refractive index sufficiently high to impart clarity to the adhesive material. Additionally, these solid materials may also impart enhanced tack and reduced wrinkling.

The alkanoate blend can be a salt derivative such as, for example, alkali metal, group II metal, group III metal, ammonium, and lower alkyl (C₁-C₄) ammonium salts of carboxylic acids. In many embodiments, the alkanoate blend includes C₁₂ to C₂₂ carboxylic acid sodium salts such as sodium stearate, sodium oleate, sodium palmitate, sodium myristate, and sodium laurate which can yield particularly favorable results.

The first and second carboxylic acid salts can be in the alkanoate blend in any useful amounts. In many embodiments, the alkanoate blend is 5 to 95 wt % first Cₙ carboxylic acid salt based on total weight of alkanoate blend and 95 to 5 wt % second Cₘ carboxylic acid salt based on total alkanoate blend, where n and m are integers in a range from 12 to 18. In many embodiments, the alkanoate blend is 10 to 90 wt % first Cₙ carboxylic acid salt based on total weight of alkanoate blend and 90 to 10 wt % second Cₘ carboxylic acid salt based on total alkanoate blend, where n and m are integers in a range from 12 to 18. In some embodiments, the first and second carboxylic acid salts are each present in the alkanoate blend in a range from 30 to 70% wt, based on the total weight of alkanoate blend. In some embodiments, the first and second carboxylic acid salts are each present in the alkanoate blend in a range from 40 to 60% wt, based on the total weight of alkanoate blend. In one embodiment, the first and second carboxylic acid salts are each present in the alkanoate blend in equal weight amounts. In illustrative embodiments, the first carboxylic acid salt and the second carboxylic acid salt have carbon chain lengths that differ in length by two carbon atoms.

In some embodiments, the first Cₙ carboxylic acid salt is a C₁₂ carboxylic acid salt (e.g., laurate salt) and the second Cₘ carboxylic acid salt is a C₁₄ carboxylic acid salt (e.g., myristate salt). In some embodiments, the first Cₙ carboxylic acid salt is a C₁₄ carboxylic acid salt (e.g., myristate salt) and the second Cₘ carboxylic acid salt is a C₁₆ carboxylic acid salt (e.g., palmitate salt). In other embodiments, the first Cₙ carboxylic acid salt is a C₁₆ carboxylic acid salt (e.g., palmitate salt) and the second Cₘ carboxylic acid salt is a C₁₈ carboxylic acid salt (e.g., stearate salt).

In some embodiments, the alkanoate blend is a first Cₙ carboxylic acid salt, a second Cₘ carboxylic acid salt, and a third C_{b} carboxylic acid salt, where n, m and b are integers in a range from 12 to 22. The first, second and third carboxylic acid salts can be in the alkanoate blend in any useful amounts. In some embodiments, the first, second and third carboxylic acid salts are each present in the alkanoate blend in a range from 20 to 40% wt, based on the total weight of alkanoate blend. In one embodiment, the first, second and third carboxylic acid salts are each present in the alkanoate blend in equal weight amounts.

In some embodiments, the first Cₙ carboxylic acid salt is a C₁₂ carboxylic acid salt (e.g., laurate salt), the second Cₘ carboxylic acid salt is a C₁₄ carboxylic acid salt (e.g., myristate salt), and the third C_{b} carboxylic acid salt is a C₁₆ carboxylic acid salt (e.g., palmitate salt). In some embodiments, the first Cₙ carboxylic acid salt is a C₁₄ carboxylic acid salt (e.g., myristate salt), the second Cₘ carboxylic acid salt is a C₁₆ carboxylic acid salt (e.g., palmitate salt), and the third C_{b} carboxylic acid salt is a C₁₈ carboxylic acid salt (e.g., stearate salt). In other embodiments, the first Cₙ carboxylic acid salt is a C₁₆ carboxylic acid salt (e.g., palmitate salt), the second Cₘ carboxylic acid salt is a C₁₈carboxylic acid salt (e.g., stearate salt), and the third C_{b} carboxylic acid salt is a C₂₀ carboxylic acid salt (e.g., arachidate salt).

The adhesives include water, liquid monohydric alcohol(s), and optionally other water-miscible organic solvents in which the alkanoate blend, polyvinylpyrrolidone, and any other solid materials are dissolved/suspended. The clear glue stick composition includes less than 0.5% wt liquid polyhydric alcohol, and in some embodiments, the clear glue stick composition is essentially free of liquid polyhydric alcohol.

Among liquid monohydric alcohols, any having fewer than about 6 carbon atoms and a melting point below about 70° F. may be used alone or in combination. Example liquid monohydric alcohols include glycol ethers such as propylene glycol monmethyl ether, butylene glycol monomethyl ether, methanol, isopropanol, amyl alcohols, and the like. In many embodiments, liquid monohydric alcohol is present in the adhesive in a range of 0.5 to 30% wt or 5 to 20% wt, and water is present in the adhesive in a range of 15 to 60% wtor20to 50% wt.

Other water miscible organic solvents may optionally be used in the glue stick compositions. For example, acetonitrile, tetrahydrofuran, dimethylformamide or dimethylsulfoxide can also be useful in small amounts. Moreover, acetone and methylethylketone can also be suitable. These auxiliary water-miscible organic solvents should constitute 20% or less of the total glue stick composition.

A water soluble or water-dispersible solid material is included in the adhesives described herein. The one or more water-soluble or water dispersible solid materials increase the solid content of the glue stick compositions and serve as a tackifier for the adhesive polymer. These materials can be chosen in such a manner that the final adhesive product has lasting initial tack, low wrinkling tendency, acceptably swift setting speed, and improved clarity. In many embodiments, these solid materials are either crystalline materials with a melting point above 70° F. (21° C.), or viscoelastic fluids having a complex shear modulus above about 200 Pa when measured at 70° F. (21° C.) and a frequency of 1 rad/s.

Water soluble or water-dispersible solid material can be dissolved or dispersed in submicron particle sizes in water at significant concentrations (e.g., up to 10% by weight or higher). In many embodiments, water soluble or water-dispersible solid materials are compounds which significantly increase the solids concentration of the aqueous phase while minimally increasing its viscosity. Further, the solid content of the glue stick composition should allow for reasonably rapid solvent evaporation as the adhesive sets.

In many embodiments, water soluble or water-dispersible solid material include crystalline sugars such as fructose, glucose, sucrose, sorbitol, mannitol, and xylitol, as well as their water-compatible esters. In addition, polymers of any molecular weight may also be used. In some embodiments, these polymers include polyesters, polyethers, polyacrylates, gelatin, polyacrylamides, their copolymers and their derivatives. Inorganic materials such as fumed silica, colloidal silica, and alkali-halide salts may also be employed as water soluble or water-dispersible solid materials. The array of materials which may be used as water-soluble or water-dispersible solids is broad and intended to be understood as such. In many embodiments, the solid materials should be greater than about 19 to 20%, and less than about 60% to 50% by weight of the total glue stick composition. In some embodiments, the solid material is present in the glue stick composition in a range from 20 to 60%, or 20 to 50%, or 30 to 50% by weight of the total glue stick composition. In many embodiments, the ratio of the solid material to the adhesive polymer concentration (PVP) is between about 0.2:1.0 and about 11.0:1.0. Further, in many embodiments the total of the solid material, liquid monohydric alcohol, and other water-miscible solvent concentrations is at least 50% of the total water content of the glue stick composition.

In some embodiments, a clear glue stick composition includes 5 to 40% wt polyvinylpyrrolidone, 3 to 20% wt alkanoate blend of a first Cₙ carboxylic acid salt and a second Cₘ carboxylic acid salt, where n and m are integers in a range from 12 to 22, 20 to 60% wt water soluble or water-dispersible solid material, 0.5 to 30% wt liquid monohydric alcohol, and 15 to 60% wt water. The clear glue stick is essentially free of liquid polyhydric alcohol. As measured through sections 0.125 mm thick, the clear glue stick has a light transmission of at least 75% at 400 nm, 500 nm, 600 nm, and 650 nm wavelengths.

It is envisioned that the glue stick compositions of the present invention may also contain minor amounts of dyestuffs as well as pigments and decorative materials. They may contain odor improving compounds such as pine-needle oil, eucalyptus oil, anise seed oil, benzaldehyde and the like. Optionally, other additives may be added in minor amounts of less than about 10% to improve performance, stability, microbial resistance, appearance, pH control and other attributes.

The glue stick compositions can have any useful pH value. In many embodiments, the glue stick composition has a pH value in a range from 6 to 11, or 6 to 9, or 6 to 7.

The present invention should not be considered limited to the particular examples described herein, but rather should be understood to cover all aspects of the invention as fairly set out in the attached claims. Various modifications, equivalent processes, as well as numerous structures to which the present invention can be applicable will be readily apparent to those of skill in the art to which the present invention is directed upon review of the instant specification.

### EXAMPLES

### Test Methods

### Adhesive Clarity Test

Visible wavelength light transmission measurement values are obtained through adhesive samples having a thickness of 0.125 mm pressed between 1 mm thick glass slides and at 21 degrees centigrade, using a spectrophotometer to record transmittance between 190 and 820 nm wavelengths, with a wavelength resolution of 2 nm.

### Adhesive Clumping Test

Each adhesive was assigned a rating based on the amount of clumping occurring during application to paper. A common glue stick container with a rotary base was used to apply the adhesive with modest hand pressure. Prior to applying the adhesive, a razor blade was used to slice away the open end of the adhesive sample, leaving a flat adhesive surface. Samples which demonstrated an appreciable tendency to deposit fractured clumps of adhesive gel during use were rated “poor,” while samples which did not tend to deposit clumps were rated “good.”

### Adhesive Wrinkling Test

Each adhesive was assigned a wrinkling rating based on the amount of wrinkling caused when two sheets of plain 20 lb. copier paper were adhered together. Distinctions between the ratings “good,” and “poor” are readily noticeable to the unaided eye.

### Sample Preparation

Each of the illustrative examples was prepared in a 1000 mL resin flask equipped with a stirring motor and heated bath. Samples were heated to temperatures of 60° to 80° C. After a homogenous mixture was formed, bubbles were removed by applying aspirator vacuum for a period of 30 to 60 seconds and the resulting sample was poured into a container and allowed to cool before use. In each of the examples below, the mold used for cooling was a common glue stick container, having an inside diameter of approximately 16 mm, with a rotary base driving a screw type advancing mechanism. Comparative product samples were used as provided.

### Example Compositions

A clear glue stick composition (“1”) and a comparative example (“C1”) are described in Table I below, using weight percentages:

TABLE I

| | 1 | C1 |
|---|---|---|
| Total water | 25.03% | 83.0% |
| PVP K90 | 11.09% | 11.0% |
| PVP K60 | 5.12% | 0.0% |
| Sucrose | 25.33% | 0.0% |
| 1-methoxy-2-propanol | 26.34% | 0.0% |
| propylene glycol | 0.00% | 0.0% |
| sodium palmitate | 3.55% | 0.0% |
| Sodium stearate | 3.55% | 6.0% |
| TOTAL | 100% | 100% |

PVP K90 and K60 refers to polyvinylpyrrolidone and is available from BASF Corporation, Mount Olive, N.J, or from International Specialty Products GAF Corporation, Wayne, N.J., USA.
Surcose is available from Aldrich Corporation, St. Louis, MO, USA
1-methoxy-2-propanol is available under the trade name “Dowanol PM” from Dow Corporation, Midland, MI.
Sodium palmitate is available from Viva Corporation, Mumbai, India
Sodium stearate is available from Viva Corporation, Mumbai, India

### Testing Results

Testing results of the Examples and comparative commercial adhesives are listed in Table II below.

TABLE II

| | Gelling agent | | | |
|---|---|---|---|---|
| | blend ratio | T_{650 nm} | | Wrinkling |
| Example | (C16:C18) | (%) | Clumping | performance |
| 1 | 1:1 | 100% | good | good |
| C1 | 0:1 | 25% | poor | poor |
| 3M | — | 33% | poor | Poor |
| Scotch ™ | | | | |
| Glue | | | | |
| Stick | | | | |
| Elmer's | — | 32% | poor | Poor |
| all | | | | |
| Purpose | | | | |
| glue stick | | | | |
| Elmer's | — | 19% | poor | Poor |
| School | | | | |
| Glue Gel | | | | |
| Glue | | | | |
| Stick | | | | |
| UHU ™ | — | 63% | poor | Poor |
| stic | | | | |

3M Scotch ® Glue Stick is available from 3M, St. Paul, IVIN.
Elmer's All-Purpose and School Glue Gel Glue Sticks are available from Elmer's Products, Inc., Columbus, OH.
UHU ™ stic is available from Saunders, Winthrop, ME

3M Scotch® Glue Stick is available from 3M, St. Paul, Minn.
Elmer's All-Purpose and School Glue Gel Glue Sticks are available from Elmer's Products, Inc., Columbus, Ohio.
UHU™ stic is available from Saunders, Winthrop, Me.

The example, comparative example, and the commercial adhesives are all capable of producing permanent, fiber-tearing paper bonds. However, the inventive example is distinct in offering reduced substrate wrinkling, improved clarity, and/or reduced clumping.

The present invention has been described with reference to several embodiments thereof. The foregoing detailed description and examples have been provided for clarity of understanding only, and no unnecessary limitations are to be understood therefrom. It will be apparent to those skilled in the art that many changes can be made to the described embodiments without departing from the spirit and scope of the invention. Thus, the scope of the invention should not be limited to the exact details of the compositions and structures described herein, but rather by the language of the claims that follow. In case of any conflict, the present specification, including definitions, shall control.

1. A glue stick composition comprising:
5 to 40% wt polyvinylpyrrolidone;
3 to 20% wt alkanoate blend comprising a first Cₙ carboxylic acid salt and a second Cₘ carboxylic acid salt, where n and m are integers in a range from 12 to 22;
20 to 60% wt of a water-soluble or water-dispersable solid material;
0.5 to 30 wt % liquid monohydric alcohol; and
15 to 60% wt water;
wherein the glue stick composition includes less than 0.5 wt % liquid polyhydric alcohol.

2. A glue stick composition according to claim 1 wherein the total weight of the water-soluble or water-dispersable solid material and the liquid monohydric alcohol is greater than 50% of the weight of the water.

3. A glue stick composition according to claim 1 wherein the glue stick composition comprises 20 to 50% wt sugar.

4. A glue stick composition according to claim 1 wherein the glue stick composition comprises 15 to 30% wt liquid monohydric alcohol.

5. A glue stick composition according to claim 1 wherein the alkanoate blend comprises 5 to 95 wt % first Cₙ carboxylic acid salt based on total weight of alkanoate blend and 95 to 5 wt % second Cₘ carboxylic acid salt based on total alkanoate blend, where n and m are integers in a range from 12 to 18.

6. A glue stick composition according to claim 1 wherein the alkanoate blend comprises a first Cₙ carboxylic acid salt, a second Cₘ carboxylic acid salt, and a third C_{b} carboxylic acid salt, where n, m and b are integers in a range from 12 to 22.

7. A glue stick composition according to claim 1 wherein the alkanoate blend comprises 5 to 95 wt % myristate salt based on total weight of alkanoate blend and 95 to 5 wt % palmitate salt based on total alkanoate blend.

8. A glue stick composition according to claim 1 wherein the alkanoate blend comprises 5 to 95 wt % palmitate salt based on total weight of alkanoate blend and 95 to 5 wt % stearate salt based on total alkanoate blend.

9. A glue stick composition according to claim 1 wherein the alkanoate blend comprises 5 to 95 wt % laurate salt based on total weight of alkanoate blend and 95 to 5 wt % myristate salt based on total alkanoate blend.

10. A clear glue stick composition comprising:
5 to 40% wt polyvinylpyrrolidone;
3 to 20% wt alkanoate blend comprising a first Cₙ carboxylic acid salt and a second Cₘ carboxylic acid salt, where n and m are integers in a range from 12 to 22;
20 to 60% wt water soluble or water-dispersible solid material;
0.5 to 30 wt % liquid monohydric alcohol; and
15 to 60% wt water;
wherein the clear glue stick composition is essentially free of liquid polyhydric alcohol; and
wherein, the clear glue stick composition has a light transmission of at least 75% according to the Adhesive Clarity Test at 400 nm, 500 nm, 600 nm, and 650 nm wavelengths.
